(19) United States
(12) Patent Application Publication
(10) Pub. No.: US 2023/0148623 A1
(43) Pub. Date: May 18, 2023

(54) COATED CHEWING GUM COMPOSITIONS

(71) Applicant: AIZANT DRUG RESEARCH SOLUTIONS PRIVATE LIMITED, Hyderabad (IN)

(72) Inventor: Rajasekara RUDRARAJU VARMA SRINIVASA, Hyderabad (IN)

(73) Assignee: AIZANT DRUG RESEARCH SOLUTIONS PRIVATE LIMITED, Hyderabad (IN)

(21) Appl. No.: 17/916,791

(22) PCT Filed: Apr. 1, 2021
(86) PCT No.: PCT/IN2021/050331

§ 371 Date: Oct. 3, 2022

(30) Foreign Application Priority Data
Apr. 3, 2020 (IN) 202041014956

(51) Int. Cl. A23G 4/10; A23G 4/06; A23G 4/20

(52) U.S. Cl. CPC A23G 4/10; A23G 4/062; A23G 4/20

(57) ABSTRACT

The present invention is related to a chewing gum compositions and method of preparing the same. Specifically, the present invention relates to chewing gum compositions comprising high-viscosity grade polymers, particularly, high-viscosity grade cellulose ethers, within the coating formulation, which provides improved crunchy texture that lasts through the initial minutes of mastication. The present invention provides stable chewing gum products comprising at least one gum core and at least one coating layer surrounding the core, wherein the coating layer comprises high-viscosity grade polymers.

### CROSS REFERENCE

This application claims priority to an Indian provisional patent application no. 202041014956, filed Apr. 03, 2020, the contents of which are incorporated herein by reference in their entireties.

### FIELD OF THE INVENTION

The present invention relates to chewing gum compositions and method of preparing the same. Specifically, the present invention relates to chewing gum compositions comprising high-viscosity grade polymers, particularly, high-viscosity grade cellulose ethers, within the coating formulation, which provides improved crunchy texture that lasts through the initial minutes of mastication.

### BACKGROUND OF THE INVENTION

The art of chewing gum manufacture is well established. Suitable gum formulations traditionally contain a substantial quantity of one or more water-insoluble elastomers, natural, synthetic, or both, flavouring agents, sweeteners and the like. Chewing gums, including pellet chewing gums, are frequently enclosed with hard or soft coatings. Coatings provide an opportunity for the manufacturer to vary product characteristics such as taste, appearance and nutritional value. Sugar-based gums with a crunch have recently become important commercially. Such gums contain crystals of sucrose, or granulated sugar, which provide the needed crunch. The crunch provided by granulated sugar is described as firm and slightly gritty in nature. An acceptable, yet-crunchy substitute needs to be found for the manufacture of crunchy sugarless gums.

In recent years, considerable research has been expended to formulate sugarless hard coatings for use in chewing gum. In order to be commercially acceptable, it is preferred that the sugarless substitute have a long chew time before the crunchiness has substantially dissipated, and a prolonged storage time. In this regard, crunch-providing gums having internally distributed crunch additives are not similar to gums having a hard outside coating, as the manufacturing and storage problems are quite different. It is also preferred that the crunch provided by the sugarless substitute be similar to that provided by granulated sugar.

Polyols known as sugar alcohols are potential candidates for providing sugarless crunch. Examples are sorbitol, mannitol, maltose, xylitol, and the like. However, in addition to providing crunch, the particular polyol must be storage stable, i.e. the crunchiness must be retained after a commercially acceptable storage time. Further, the flavouring agents and softeners in the gum product should not soften the polyol and thus reduce the crunch, and the process for formation of the additive should be economically feasible. U.S. Pat. Nos. 5,958,472 and 5,536,511 disclose the use of polyol coatings to achieve desirable crunch and texture.

U.S. Pat. No. 4,127,677 to Fronczkowski et al. discloses a xylitol coated chewing gum containing from 95 to 99.5% xylitol which may be used as a coating for sugarless gums. However, for various reasons, xylitol containing chewing gums have not received satisfactory consumer acceptance.

Sorbitol, long used as a plasticizer and sweetener, has been suggested as a substitute for sugar in forming sugarless candy coatings for sugarless chewing gums. Unfortunately, however, it has been found that when sorbitol is applied in an aqueous coating solution to chewing gum cores, the sorbitol does not recrystallize to form a thin crystalline coat.

Moreover, the chewing gum cores subjected to the sorbitol chewing step stick to one another forming undesirable clumps.

Prior art also exists wherein particulate matter has been incorporated into chewing gum compositions such that the resultant product does have a somewhat “crunchy” texture. For example chewing gums with a “crunchy” exterior coating have been previously disclosed such as the hard sugar coated gums disclosed in U.S. Pat. Nos. 4,486,511 and 4,792,453 and gums with surface printed solid particles disclosed in U.S. Pat. No. 3,962,463. Such disclosures are limited to a “crunchy” exterior surface of the gum and thus do not provide an overall texture sensation.

Furthermore, confectionery gums wherein sugars and sugar substitutes (such as isomalt, candy and the like), sometimes in conjunction with freeze dried food stuffs, are distributed throughout the body of the gum for the purpose, at least in part, of providing a “crunchy” texture are also known (FR 2,748,902; GB 950,811; EP 017,691; U.S. Pat. Nos. 5,958,472 and 5,017,385). Whilst these latter disclosures do provide useful advances in conferring a “crunchy” sensation to the gum they do so by the use of food stuffs and not by use of the oral care active itself.

It would be desirable to provide a sugarless additive which can be utilized to form a chewing gum product having a crunchy feel, in particular, a crunchy feel similar to that provided by granulated sugar, and which maintains this crunchy feel over an extended period of chew time. It would be further desirable to provide a gum having a crunchy feel which maintains this characteristic under commercially desirable storage conditions.

### SUMMARY OF THE INVENTION

Thus, the object of the present invention is to provide stable chewing gum compositions that will overcome the drawbacks in the prior art and provide improved crunchy texture that lasts through the initial minutes of mastication.

In one embodiment the present invention provides stable chewing gum products comprising at least one gum core and at least one coating layer surrounding the core, wherein the coating layer comprises high-viscosity grade polymers.

In another embodiment the present invention provides stable chewing gum compositions that provides improved crunchy texture, and comprises at least one gum core and at least one coating layer surrounding the core, wherein the coating layer, typically the outer coating layer, comprises high-viscosity grade polymers, particularly, high-viscosity grade cellulose ethers.

Further, in another embodiment, the present invention provides stable chewing gum compositions that provides improved crunchy texture, and comprises at least one gum core and at least one coating layer surrounding the core, wherein the coating layer, typically the outer coating layer, comprises high-viscosity grade polymers, particularly, high-viscosity grade cellulose ethers; and wherein the gum core comprises one or more biologically active ingredients.

In yet another embodiment, the present invention provides stable coated chewing gums that can be manufactured by tablet compression techniques, and thus, do not require the specific (e.g. melt extrusion) equipment necessary in the manufacture of conventional chewing gums.

### DETAILED DESCRIPTION OF THE INVENTION

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

The present invention relates to stable chewing gum compositions that provide improved crunchy texture and the method of preparing the same.

The term “chewing gum” as used herein also includes bubble gum and the like. Unless indicated otherwise, all percentages are given in weight percent.

The present invention provides stable chewing gum compositions that provides improved crunchy texture, and comprises at least one gum core and at least one coating layer surrounding the core, wherein the coating layer, typically the outer coating layer, comprises high-viscosity grade polymers, particularly, high-viscosity grade cellulose ethers.

A significant characteristic of the high-viscosity grade cellulose ethers is that they are non-toxic, non-ionic, inert, and, edible. They are widely used in the pharmaceutical industry as film-forming agent, thickener, blocker, sustained-release agent, emulsifying agent and suspending agent in a variety of dosage forms, thus making all kinds of pharmaceutical formulations more evenly dispersed, or with sustained release effects or stable emulsions without stratification.

The present inventors have surprisingly found out that the incorporation of high-viscosity grade cellulose ethers in the coating layer surrounding a gum core, provided a crunch, in particular, a desirable crunch having texture and mouth feel, to the finished gum composition, similar to that provided by granulated sugar.

The present inventors have surprisingly found out that the incorporation of high-viscosity grade cellulose ethers in the coating layer surrounding a gum core, provided a crunch, in particular, a desirable crunch having texture and mouth feel, to the finished gum composition, similar to that provided by granulated sugar without impacting the release profiles of pharmaceutical active ingredients incorporated in the chewing gum cores.

The particular cellulose ethers which are useful in the present invention are those which are of a high-viscosity grade. By “high-viscosity grade” is meant those cellulose ethers that, when in a 2 weight percent aqueous solution, exhibit a viscosity at 20° C. of greater than about 1000 centipoise (cP) (1000 mPa·s) and may have a viscosity as high as 100,000 cP (100,000 mPa·s). Such viscosities may generally be measured by conventional methods, for example, by measuring the viscosity of an aqueous solution of the polymers at the desired concentration in Ubbelohde capillary tubes at the specified temperature.

Some of the high-viscosity grade cellulose ethers, in the various embodiments, belong to the chemical categories hydroxypropylmethylcellulose, methylcellulose, or hydroxyethylcellulose. Examples of suitable cellulose ethers of the present invention include those which may be obtained commercially, such as METHOCEL™ (available from The Dow Chemical Company, Midland, Mich. USA) and METOLOSE™ or PHARMACOAT™ (available from the Shin-etsu Chemical Company, Tokyo, Japan). The METHOCEL™ cellulose ethers, for example, are particularly advantageous because they can be obtained in a wide variety of molecular weights, substitution patterns, and viscosity characteristics. In particular, hydroxypropylmethylcelluloses sold as the METHOCEL™ K series, and certain polymers and polymer combinations within the METHOCEL™ E, F, and J series, are particularly suitable. Certain higher molecular weight methylcellulose polymers within the METHOCEL™ A series are also suitable.

As used herein, the term “stable” means that the formulation has an acceptable pharmaceutical shelf life of at least 12 months, preferably at least 24 months, when stored at 25° C. and at a relative humidity of 60% in a conventional pharmaceutical packaging. Thus in one embodiment of the invention, the chewing gums are chemically and physically stable and have a shelf life of at least 12 months, preferably at least 24 months, when stored at 25° C. and at a relative humidity of 60% in a conventional pharmaceutical packaging.

The present invention also provides stable chewing gum compositions that is characterized by improved crunchy texture and mouth feel, and comprises at least one gum core and at least one coating layer surrounding the core, wherein the coating layer, typically the outer coating layer, comprises high-viscosity grade polymers, particularly, high-viscosity grade cellulose ethers; and wherein the gum core comprises one or more biologically active ingredients.

The chewing gum compositions of the present invention may comprise one or more of the following active agents: a physiologically active ingredient, nutritional supplement or pharmaceutically active ingredient. Non-limiting examples of active agents include, but are not limited to vitamin, enzyme, amino acid supplement, protein, gum, carbohydrate, phytochemical, dextrose, lecithin, other trace nutrient, brain-stimulating substance, energy provider, a mineral, mineral salt, botanical extract, antioxidant, prebiotic, probiotic bacteria, fatty acid, oat beta glucan or other functional fiber, creatine, carnitine, bicarbonate, citrate, vivazol, or any mixture thereof.

The amount of active ingredient present in the chewing gum may depend on requirements and the actual ingredient used. For instance, some active ingredients have high functional activity at very low doses such as vitamins and minerals (micronutrients), whereas others such as dextrose (macronutrients) are beneficial to the body in much higher amounts.

In general, a chewing gum composition typically contains a chewable gum base portion which is essentially free of water and is water-insoluble, a water-soluble bulk portion and flavors which are typically water insoluble. The water-soluble portion dissipates with a portion of the flavor over a period of time during chewing. The gum base portion is retained in the mouth throughout the chew. The chewing gum compositions of the present invention follow the general pattern outlined above.

The insoluble gum base generally comprises elastomers, elastomer solvents, plasticizers, waxes, emulsifiers and inorganic fillers. Plastic polymers, such as polyvinyl acetate, which behave somewhat as plasticizers, are also often included. Other plastic polymers that may be used include polyvinyl laureate, polyvinyl alcohol and polyvinyl pyrrolidone. Further, gum bases may also contain optional ingredients such as antioxidants, colors and flavors.

According to the preferred embodiment of the present invention, the insoluble gum base constitutes between about 5% to about 95% of the gum. The present invention contemplates employing any commercially acceptable gum base.

The water-soluble portion of the chewing gum may further comprise softeners, sweeteners, flavoring agents and combinations thereof. The sweeteners often fulfill the role of bulking agents in the gum. The bulking agents typically comprise about 5% to about 95% of the gum composition.

The present inventors have also found that the coating layers surrounding the gum core are critical to the efficient release of biologically active ingredient from the composition and its rapid transmucosal uptake in the oral cavity of the subject. Thus, another feature of the present invention is the judicious selection and application of the various types of coating layers surrounding the gum core, as a result a superior cost-effective chewing gum product is obtained that provide a high rate of release of biologically active ingredient from the chewing gum and an environment in the oral mucosa that enhance buccal absorption of the active.

Moreover, the presence of a coating increases the stability of the chewing gum by hampering access of water and oxygen to the uncoated chewing gum core. Typically, polyol coatings come into consideration, of which the sugar free coating formulations are preferred.

Thus, in one embodiment, the chewing gums of the invention are coated with a coating that comprises at least one polyol, preferably and surprisingly xylitol. Typically, the amount of coating is approximately 5-50%, preferably 10-30%, of the uncoated chewing gum. Typically, a sugar free coating mixture comprises a polyol (e.g. maltitol, sorbitol, mannitol, xylitol, erythritol, lactitol or isomalt) a binder, be it, e.g., (a) a gum (e.g. arabic gum, tragacanth gum, guar gum, acacia gum, xanthan gum, alginic acid, salts of alginic acid e.g. sodium alginate, gellan gum, glucomannan gum, carrageenan gum, karaya gum, locust bean gum or tara gum, in particular arabic gum) or (b) a protein-type binder such as gelatin; and optionally flavors, dyes, and traces of any polishing agents used (especially talc and/or Carnauba wax).

The chewing gums of the present invention further comprise of at least one flavored coating. These coatings allow for addition of a large percentage of flavors thereby aiding in prolonging the flavoring sensation.

The flavoring agents may comprise one or more synthetic or natural flavouring or aromatizing agents.

Flavoring agents may be selected from essential oils including distillations, solvent extractions, or cold expressions of chopped flowers, leaves, peel or pulped whole fruit comprising mixtures of alcohols, esters, aldehydes and lactones; essences including either diluted solutions of essential oils, or mixtures of synthetic chemicals blended to match the natural flavour of the fruit, e.g., strawberry, raspberry and black currant;

artificial and natural flavours of brews and liquors, e.g., cognac, whisky, rum, gin, sherry, port, and wine; tobacco, coffee, tea, cocoa, and mint; fruit juices including expelled juice from washed, scrubbed fruits such as lemon, orange, and lime; spear mint, pepper mint, wintergreen, cinnamon, cacoe/cocoa, vanilla, liquorice, menthol, eucalyptus, aniseeds nuts (e.g., peanuts, coconuts, hazelnuts, chestnuts, walnuts, colanuts), almonds, raisins; and powder, flour, or vegetable material parts including tobacco plant parts, e.g., genus Nicotiana, in amounts not contributing significantly to the level of nicotine, and ginger.

In a typical embodiment, the chewing gums of the present invention are coated with a flavored coating that further comprises a binder preferably selected from, but not limited to, the group consisting of hydroxypropyl cellulose, hydroxypropylmethyl cellulose, hydroxyethyl cellulose, polyvinyl pyrrolidone, carboxymethyl cellulose, polyvinyl alcohol, sodium alginate, polyethylene glycol, pullulan, tragacanth gum, guar gum, acacia gum, arabic gum, polyacrylic acid, methylmethacrylate copolymer, carboxyvinyl polymer, amylose, high amylose starch, hydroxypropylated high amylose starch, dextrin, pectin, chitin, chitosan, gelatin, zein, gluten, soy protein isolate, whey protein-isolate, casein and mixtures thereof.

In a preferred embodiment of the invention, the chewing gums of the present invention are coated with a flavored coating that comprises a flavoring agent as defined above, in particular mint flavor; and a binder as defined above, in particular hypromellose. Typically, the binder is present in an amount of 0.5-30% of the total coating mass.

In an embodiment of the invention, the chewing gum cores may be coated with a seal coat and a flavor coat where in high-viscosity grade cellulose polymer is incorporated in flavor coating.

In yet another embodiment of the invention, the chewing gum cores may be coated with flavor coat wherein high-viscosity grade cellulose polymer is incorporated in flavor coating.

In an embodiment of the invention, the chewing gum cores may be coated with a seal coat and a flavor coat, where in high-viscosity grade polymer is incorporated in either of the coats or both the coating layers.

The chewing gums of the present composition may further comprise an outer glow coating over the outer hard coating.

Other additives may be added optionally to the chewing gum core and/or to coating layers in the chewing gum.

Optional additives comprise at least one or more additive selected from the group consisting of stabilizers, preservatives, e.g., antioxidants; softeners, thickening agents, emulsifiers, glidants, lubricants, sweeteners, gelling agents, enhancers, coloring agents, vitamins, minerals, fluorine and tooth whitening agents and mixtures thereof. According to the invention, at least one of such additives is optionally added to the product.

Enhancers are added essentially to improve, i.e., increase, the transmucosal uptake from the oral cavity.

Sweeteners are added essentially to improve the taste.

Sweeteners comprise one or more synthetic or natural sugars, i.e., any form of carbohydrates suitable for use as sweetener, as well as so called artificial sweeteners such as saccharin, sodium saccharin, aspartame, e.g., NutraSweet.RTM., or acesulfame, potassium acesulfame, thaumatin, glycyrrhizin, sucralose, dihydrochalcone, alitame, miraculin, monellin.

Suitable sweeteners may be selected from the group consisting of sugar alcohols, such as sorbitol, xylitol, single sugars including sugars extracted from sugar cane and sugar beet (sucrose), dextrose (also called glucose), fructose (also called leavulose), and lactose (also called milk sugar); sorbitol, mannitol, glycerol, xylitol, maltitol syrup (or hydrogenated starch hydrolyzate), isomalt, lactitol; and mixtures of sugars including glucose syrup, e.g., starch hydrolysates, containing a mixture of dextrose, maltose and a range of complex sugars, invert sugar syrup, e.g., sucrose inverted by invertase (also called sucrase or sacchrase) containing a mixture of dextrose and fructose, high sugar content syrups such as treacle and honey containing a mixture of particular leavulose, dextrose, maltose, lactitole, sucrose, resins, dextrin and higher sugars; and malt or malt extracts.

Colouring additives may be selected from dyes being approved as a food additive.

Stabilizing additives may be selected from the group consisting of antioxidants including vitamin E, i.e., tocopherole, ascorbic acid, sodium pyrosulfite, butylhydroxytoluene, butylated hydroxyanisole, edetic acid and edetate salts; and preservatives including citric acid, tartaric acid, lactic acid, malic acid, acetic acid, benzoic acid, and sorbic acid. Preferred embodiments comprise an antioxidant as the stabiliser, and even more preferably the antioxidant vitamin E and/or butylated hydro xytoluene (BHT).

The present invention further provides crunchy chewing gums that can be manufactured by tabletting techniques, and thus, do not require the specific (e.g. melt extrusion) equipment necessary in the manufacture of conventional chewing gums.

The term “tabletting” on the one hand includes, preferably, conventional tabletting techniques but also, on the other hand, any sophisticated ones. They all have in common the application of force, i.e. the compression of the mixture of all components of the chewing gum.

Coated chewing gum products according to the invention can be maintained in several production steps depending on the total number of cores and the total number of coated layers to be included.

A typical method for the production of the coated chewing gum according to the invention is disclosed. The method comprises the steps of
a) providing a chewing gum core,
b) providing at least one coating layer comprising high-viscosity cellulose ether, and
c) coating the chewing gum core with the coating layer.

In one of the preferred embodiments of the present invention, the chewing gum was prepared by the following steps:
a) The biologically active ingredient is dispersed in liquid flavoring agent;
b) The dispersion obtained in step a) is then adsorbed on gum base;
c) The active adsorbed gum base obtained in step b) are then blended with other pharmaceutically acceptable excipients to get a uniform free-flowing mass;
d) The blend obtained in step c) is then granulated and compressed to form tablets; and
e) The compressed gum cores or tablets obtained in step d) are then coated with at least one coating layer containing high-viscosity cellulose ether by:
   i. press coating, and/or
   ii. spray coating, and/or
   iii. melt coating.

In the mouth, the chewing gum initially has a crunchy texture which lasts the initial minutes of mastication and then becomes a normal cohesive chewing gum.

The principles, preferred embodiments, and modes of operation of the present invention have been described in the foregoing specification. The invention which is intended to be protected herein, however, is not to be construed limited to the particular forms disclosed, since these are to be regarded as illustrative rather than restrictive. Variations and changes may be made by those skilled in the art, without departing from the spirit of the invention.

The following examples further illustrate the invention but should not be construed as in any way limiting its scope. In particular, the processing conditions are merely exemplary and can be readily varied by one of ordinary skill in the art.

### EXAMPLES:

### Example 1: Coating Composition

| | | |
|---|---|---|
| S. No | Ingredients | mg/gum |

Seal Coating

| | | |
|---|---|---|
| 1 | PEG 6000 | 1-10 |
| 2 | HPMC E5 LV | 5-15 |
| 3 | HPMC E15 LV | 5-20 |
| 4 | Purified water | Qs |

Flavour coating

| | | |
|---|---|---|
| 5 | HPMC K100 LV CR | 2-20 |
| 6 | Xylitol | 50-250 |
| 7 | Titanium dioxide | 1-10 |
| 8 | Talc | 0.5-5 |
| 9 | Flavour | 1-10 |
| 10 | Purified water | Qs |

Glow coating

| | | |
|---|---|---|
| 11 | Instaglow | 1-10 |
| 12 | Purified water | Qs |

### Example 2: Coating Composition

| | | |
|---|---|---|
| S. No | Ingredients | mg/gum |

Flavour coating

| | | |
|---|---|---|
| 1 | HPMC K100 LV CR | 2-20 |
| 2 | Xylitol | 50-200 |
| 3 | Titanium dioxide | 1-10 |
| 4 | Talc | 0.5-5 |
| 5 | Flavour | 1-10 |
| 6 | Purified water | Qs |

Glow coating

| | | |
|---|---|---|
| 7 | Instaglow | 1-10 |
| 8 | Purified water | Qs |

### Example 3: Coating Composition

| | | |
|---|---|---|
| S. No | Ingredients | mg/gum |

Seal Coating

| | | |
|---|---|---|
| 1 | PEG 6000 | 1-10 |
| 2 | HPMC E5 LV | 5-15 |
| 3 | HPMC K100 LV CR | 5-20 |
| 4 | Purified water | Qs |

Flavour coating

| | | |
|---|---|---|
| 5 | HPMC K100 LV CR | 2-20 |
| 6 | Xylitol | 50-200 |
| 7 | Titanium dioxide | 1-10 |
| 8 | Talc | 0.5-5 |
| 9 | Flavour | 1-10 |
| 10 | Purified water | Qs |

Glow coating

| | | |
|---|---|---|
| 11 | Instaglow | 1-10 |
| 12 | Purified water | Qs |

### Example 4: Coating Composition

| | | |
|---|---|---|
| S. No | Ingredients | mg/gum |

Seal Coating

| | | |
|---|---|---|
| 1 | PEG 6000 | 1-10 |
| 2 | HPMC K100 LV CR | 5-20 |
| 3 | Purified water | Qs |

Flavour coating

| | | |
|---|---|---|
| 4 | HPMC K100 LV CR | 2-20 |
| 5 | Xylitol | 50-200 |
| 6 | Titanium dioxide | 1-10 |
| 7 | Talc | 0.5-5 |
| 8 | Flavour | 1-10 |
| 9 | Purified water | Qs |

Glow coating

| | | |
|---|---|---|
| 10 | Instaglow | 1-10 |
| 11 | Purified water | Qs |

### Example 5: Coated chewing gum composition

### I. Preparation of Gum Core

| Component | % w/w |
|---|---|
| Gum Base | 93.0 |
| Sodium carbonate anhydrous | 1.62 |
| Sodium hydrogen carbonate | 0.57 |
| Silica, colloidal hydrated | 1.67 |
| Magnesium stearate | 1.67 |
| Flavour | 0.83 |
| Acesulfame potassium | 0.64 |

### Procedure:

a) The flavour was adsorbed to a part of the gum base,
b) Colloidal silica was added to the mixer in step a) and kneaded for sufficient time at suitable speed to form granules,
c) The remaining ingredients, except magnesium stearate, were mixed with the remaining part of the gum base,
d) The extragranular mass obtained in step c) was then blended with the flavour adsorbed granules of step (b),
e) The blend obtained in step d) was then lubricated and compressed.

### II. Preparation of Coated Chewing Gum Composition

| | |
|---|---|
| Ingredients | mg/gum |

Seal coating

| | |
|---|---|
| Polyethylene glycol 6000 | 2.55 |
| Hydroxypropyl methyl cellulose E5 LV | 12.34 |
| Hydroxypropyl methyl cellulose E15 LV | 10.64 |
| Purified water | QS |

Flavour coating

| | |
|---|---|
| Xylitol | 201.99 |
| Hydroxypropyl methyl cellulose K100 LVCR | 10.64 |
| White ice mint | 4 |
| Talc | 1.55 |
| Titanium dioxide | 6.27 |
| Ferric oxide (yellow) | 0.1 |
| Purified water | QS |

Glow Coating

| | |
|---|---|
| Insta glow | 5.32 |
| Purified water | QS |
| | 1532.4 |

### Procedure:

### i) Seal Coating:

a) Polyethylene glycol 6000 was dissolved in purified water and stirred continuously until clear solution was formed.
b) Hypromellose E5 LV was added to clear solution obtained in step a) and stirred continuously until clear viscous solution was formed.
c) Hypromellose E15 LV was added to solution obtained in step b) and stirred continuously until clear viscous solution was formed.
d) The gum cores were transferred to the coating pan and pre-warmed.
e) The coating solution was sprayed on to the gum core bed by continuous film coating process.
f) The coated gum cores were then dried.

### ii) Flavour Coating:

g) Ferric oxide (yellow) was sifted and added to purified water under continuous stirring.
h) Hydroxy Propyl Methyl cellulose K100 LVCR was dissolved to the solution obtained in step g) and stirred continuously until yellow colored clear viscous solution was formed.
i) Xylitol was dissolved in required quantity of water and stirred continuously until clear viscous solution was formed.
j) Talc and Titanium dioxide were dispersed in required quantity of water and homogenized until a uniform dispersion was formed.
k) Xylitol solution of step i) was added to the HPMC K100 LCVR solution of step h) and mixed to attain uniformity.
l) White ice mint flavour was added to the solution obtained in step k) and stirred continuously.
m) Titanium dioxide and Talc dispersion of step j) was added to solution obtained in step 1) along with remaining amount of purified water and stirred continuously to attain uniformity.
n) Seal coated gum cores obtained in step f) were pre-warmed and the coating dispersion obtained in step m) was sprayed on to the seal coated gum bed by continuous film coating process.
o) The flavour coated gum cores were then dried.
   iii) Glow Coating:
p) Insta glow was dissolved in required quantity of purified water.
q) Flavour coated gum cores obtained in step o) were pre-warmed and the coating solution obtained in step p) was sprayed on to the seal coated gum bed by continuous film coating process.
r) The coated gum cores were then dried.

### Example 6: Comparative Chew Studies

Two-fold chew studies were conducted to evaluate: (1) duration of crunch over time and (2) organoleptic effects.

### Duration of Crunch Over Time

Two sets of coated chewing gums (Inventive Example-A and Comparative Example-B) were prepared using the core composition provided in Example-5). Inventive Example-A was coated as per the coating composition illustrated Example-5) and Comparative Example-B was coated with the following coating composition:

| | |
|---|---|
| Ingredients | mg/gum |

Polyol coating

| | |
|---|---|
| Xylitol | 10.5 |
| Xanthum gum | 0.06 |
| Talc | 0.20 |
| dye | 0.30 |
| Purified water | QS |

Flavour coating

| | |
|---|---|
| Mint flavor | 0.75 |
| Xylitol | 2.75 |
| Talc | 0.03 |
| Dye | 0.1 |
| Purified water | QS |

### Procedure:

a) Xanthum gum was dissolved in required quantity of purified water under continuous stirring to get a clear viscous solution ,
b) Xylitol, talc and the dye were added to the solution of step a) and stirred continuously.
c) The gum cores obtained as per Example-5) were transferred to a coating pan and the coating dispersion obtained in step b) was sprayed on to the cores, and the coated cores were dried.
d) The ingredients of the flavour coat were added to purified water one at a time and stirred continuously.
e) The coating dispersion obtained in step d) was sprayed on to the polyol coated gum cores obtained in step c).
f) The coated gum cores of step e) were then coated with a solution Insta glow in purified water and dried.

After tempering for 10 days at room temperature, the two sets of chewing gum products were then stored at 85° F. and 70% relative humidity and tested for crunchiness over a period of about 2 months.

The test involved one or more individuals who test the crunchiness of the pellet coating by biting into it and rating the crunch on a scale of 0 to 5, with 0 being very low in crunchiness and 5 being high in crunchiness. The results are shown in Table-1.

TABLE 1
Crunch of Chewing Gum

| Time | Comparative | Inventive |
|---|---|---|
| (in weeks) | Example B | Example A |
| 0 | 4 | 5 |
| 1 | 3 | 5 |
| 2 | 2 | 5 |
| 3 | 1.5 | 4.5 |
| 4 | 1 | 4.5 |
| 5 | 1 | 4 |
| 6 | 0 | 4.5 |
| 7 | 0 | 4 |
| 8 | 0 | 4 |
| 9 | 0 | 4 |

Table-1 shows that the chewing gum products of Inventive Example-A maintained a high level of crunch for a significantly longer period of time than the chewing gum products of Comparative Example-B.

### Organoleptic effects

The two sets of coated chewing gum products (Inventive Example-A and Comparative Example-B) were concomitantly evaluated for organoleptic impressions (sensory impressions) during the crunch duration tests.

The expert panel found that the gum products of Inventive Example-A had a smooth surface and provided a crunch which was very similar to that of granulated sugar, firm and slightly gritty in nature, the desired texture and effect necessary for a “crunch” gum. The crunch remained consistent for 2+ minutes and gradually diminished during a 5 minute chew. The gum products of Comparative Example-B were found to have a rough surface; and were evaluated to be softer and less crunchy by comparison.

Having now fully described the invention, it will be apparent to one of ordinary skill in the art that many changes and modifications can be made thereto without departing from the spirit or scope of the invention as set forth herein.

We claim:

1. A coating composition for providing crunch to a chewing gum, wherein the coating composition comprises high-viscosity grade polymer having a viscosity characteristic of from about 1000 centipoise (cP) (1000 mPa·s) to about 100,000 cP (100,000 mPa·s) when in a 2 weight percent aqueous solution at 20° C.

2. The coating composition as claimed in claim 1, wherein said high-viscosity grade polymer is high-viscosity grade cellulose ether.

3. The coating composition as claimed in claim 1, wherein said high-viscosity grade cellulose ether is selected from the group consisting of hydroxypropylmethylcellulose, methylcellulose and hydroxyethylcellulose, or a mixture thereof.

4. An improved crunch chewing gum product comprising:
i. a gum core, and
ii. at least one coating surrounding the core;
wherein coating portion comprises high-viscosity grade polymer having a viscosity characteristic of from about 1000 centipoise (cP) (1000 mPa·s) to about 100,000 cP (100,000 mPa·s) when in a 2 weight percent aqueous solution at 20° C.

5. The chewing gum product as claimed in claim 4, wherein said high-viscosity grade polymer is high-viscosity grade cellulose ether.

6. The chewing gum product as claimed in claim 4, wherein said high-viscosity grade cellulose ether is selected from the group consisting of hydroxypropylmethylcellulose, methylcellulose and hydroxyethylcellulose, or a mixture thereof.

7. The chewing gum product as claimed in claim 4, comprising:
i. a core comprising a compressible chewing gum base and at least one biologically active ingredient;
ii. at least one coating surrounding the core;
wherein coating portion comprises high-viscosity grade polymer having a viscosity characteristic of from about 1000 centipoise (cP) (1000 mPa·s) to about 100,000 cP (100,000 mPa·s) when in a 2 weight percent aqueous solution at 20° C.

8. The chewing gum product as claimed in claim 4, wherein the chewing gum further comprises at least one or more additives selected from the group consisting of stabilizers, preservatives, antioxidants, softeners, thickening agents, emulsifiers, glidants, lubricants, sweeteners, gelling agents, enhancers, coloring agents, vitamins, minerals, fluorine and tooth whitening agents and mixtures thereof.
